(19) United States
(12) Patent Application Publication
(10) Pub. No.: US 2022/0179066 A1
(43) Pub. Date: Jun. 9, 2022

(54) CONNECTING EXTERNAL MOUNTED IMAGING AND SENSOR DEVICES TO ELECTRICAL SYSTEM OF A VEHICLE

(71) Applicant: DIGITAL DIRECT IR, INC., Fresh Meadows, NY (US)

(72) Inventor: Peter N. Kaufman, Fresh Meadows, NY (US)

(21) Appl. No.: 17/493,765

(22) Filed: Oct. 4, 2021

Related U.S. Application Data
(60) Provisional application No. 63/087,229, filed on Oct. 4, 2020.

(51) Int. Cl. G01S 13/931; B60R 11/04; G01S 17/931; G01S 7/02

(52) U.S. Cl. CPC G01S 13/931; B60R 11/04; B60R 2011/0026; G01S 7/027; G01S 2013/93271; G01S 17/931

(57) ABSTRACT

A system comprises a first housing unit configured to mount to an external surface of a vehicle, wherein the first housing unit comprises a first coupler module, and electronic devices configured to enable object detection, wherein the electronic devices comprise an imaging system configured to generate image data of an incident scene in proximity to the vehicle. The system comprises a second housing unit configured to mount to an inner surface of the vehicle, in alignment with the first housing unit, wherein the second housing unit comprises a second coupler module. The first and second coupler modules are configured to interface and cooperatively operate to enable (i) wireless transfer of power from an electrical system of the vehicle to the electronic devices in the first housing unit and (i) wireless bidirectional communication between the electronic devices within the first housing unit and a computer system of the vehicle.

### CROSS-REFERENCE TO RELATED APPLICATION

This application claims the benefit of U.S. Provisional Application No. 63/087,229, filed on Oct. 4, 2020, the disclosure of which is fully incorporated herein by reference.

### BACKGROUND

This disclosure generally relates to techniques for mounting external imagers and sensors outside a vehicle and connecting such external imagers and sensors to an electrical system of the vehicle. The current and future automotive market requires multiple modes of external sensor modalities to facilitate automated driver-assistance systems (ADAS) as well as other automated systems for the development and implementation of various types of autonomous vehicles (e.g., cars, trucks, trains, taxis, busses, boats, etc.). As is known in the art, ADAS comprise groups of electronic systems that are configured to assist individuals in driving and parking their vehicle. For example, ADAS utilize automated technology, such as sensors (e.g., LIDAR (light detection and ranging) sensor, RADAR (radio detection and ranging) sensors, ultrasonic sensors, etc.) and cameras (e.g., visible light cameras, infrared (IR) cameras, etc.), to detect nearby obstacles or driver errors, and respond accordingly.

In addition, autonomous vehicles (e.g., self-driving vehicles) employ a wide range of sensor and imager technologies to automatically control operation of a motor vehicle and safely navigate the motor vehicle as is operates on roads. For ADAS and autonomous vehicle applications, the various sensor and imager technologies are used in conjunction with one another, as each one provides a layer of autonomy that helps make the entire system more reliable and robust. However, to achieve optimal performance of control systems for ADAS and autonomous vehicles, it may be necessary to position such sensors and imagers on a given vehicle in a location where conventional wired interconnects are not practical.

### SUMMARY

Exemplary embodiments of the disclosure include systems and methods for mounting external imagers and sensors outside a vehicle and connecting such external imagers and sensors to an electrical system of the vehicle using wireless connections. For example, an exemplary embodiment includes a system which comprises: a first housing unit configured to mount to an external surface of a vehicle, wherein the first housing unit comprises a first coupler module, and electronic devices configured to enable object detection, wherein the electronic devices comprise an imaging system configured to generate image data of an incident scene in proximity to the vehicle; and a second housing unit configured to mount to an inner surface of the vehicle, in alignment with the first housing unit, wherein the second housing unit comprises a second coupler module. The first coupler module and the second coupler module are configured to interface and cooperatively operate to enable (i) wireless transfer of power from an electrical system of the vehicle to the electronic devices in the first housing unit and (i) wireless bidirectional communication between the electronic devices within the first housing unit and a computer system of the vehicle.

In one embodiment, the external and inner surfaces of the vehicle comprise external and inner surfaces of a windshield of the vehicle.

In another embodiment, the external and inner surfaces of the vehicle comprise external and inner surfaces of a rear window of the vehicle.

In another embodiment, the external and inner surfaces of the vehicle comprise external and inner surfaces of a roof panel of the vehicle.

Other embodiments will be described in the following detailed description of exemplary embodiments, which is to be read in conjunction with the accompanying figures.

### BRIEF DESCRIPTION OF THE DRAWINGS

FIG. 1A schematically illustrates a configuration for externally mounting a forward-looking imaging device on a roof of a vehicle, according to an exemplary embodiment of the disclosure.

FIG. 1B schematically illustrates the external roof-mounted imaging device of FIG. 1A providing an optimal field-of-view for forward-looking object detection, according to an exemplary embodiment of the disclosure.

FIG. 2A schematically illustrates a configuration for externally mounting a forward-looking imaging device on a windshield of a vehicle, according to an exemplary embodiment of the disclosure.

FIG. 2B schematically illustrates the external windshield-mounted imaging device of FIG. 2A providing an optimal field-of-view for forward-looking object detection, according to an exemplary embodiment of the disclosure.

FIG. 3 schematically illustrates a configuration for externally mounting a rearward-looking imaging device on a roof of a vehicle, according to an exemplary embodiment of the disclosure.

FIG. 4 schematically illustrates a configuration for externally mounting a rearward-looking imaging device on back window of a vehicle, according to an exemplary embodiment of the disclosure.

FIG. 5 schematically illustrates a configuration for externally mounting a dual-direction imaging device on a roof of a vehicle, according to an exemplary embodiment of the disclosure.

FIG. 6 schematically illustrates a configuration for externally mounting a dual-direction imaging device on a roof of a vehicle, according to another exemplary embodiment of the disclosure.

FIGS. 7A and 7B schematically illustrate a configuration for externally mounting a 360-degree imaging system on a roof of a vehicle, according to an exemplary embodiment of the disclosure.

FIG. 8 schematically illustrates a system to enable wireless coupling of power and data communication to external device electronics mounted on an outside of a vehicle, according to an exemplary embodiment of the disclosure.

FIG. 9 schematically illustrates a power coupling system which is configured to enable wireless transfer of power from an electrical system of a vehicle to external device electronics mounted on an outside of the vehicle, according to an exemplary embodiment of the disclosure.

FIG. 10 schematically illustrates a power coupling system which is configured to enable wireless transfer of power from an electrical system of a vehicle to external device electronics mounted on an outside of the vehicle, according to another exemplary embodiment of the disclosure.

FIG. 11 schematically illustrates a data transfer system which is configured to enable wireless bi-directional communication of data between a vehicle computer system and external device electronics mounted on an outside of the vehicle, according to an exemplary embodiment of the disclosure.

FIG. 12 schematically illustrates a data transfer system which is configured to enable wireless bi-directional communication of data between a vehicle computer system and external device electronics mounted on an outside of the vehicle, according to another exemplary embodiment of the disclosure.

FIG. 13 schematically illustrates a configuration for externally mounting a forward-looking object detection system on a windshield of a vehicle, according to an exemplary embodiment of the disclosure.

FIG. 14 schematically illustrates a configuration for externally mounting a forward-looking object detection system on a roof a vehicle, according to an exemplary embodiment of the disclosure.

FIGS. 15A and 15B schematically illustrates a configuration for externally mounting a forward-looking object detection system on windshield of a vehicle, according to another exemplary embodiment of the disclosure.

### DETAILED DESCRIPTION

Embodiments of the disclosure will now be described in further detail with regard to systems and methods for mounting external imagers and sensors outside a vehicle and connecting such external imagers and sensors to an electrical system of the vehicle using wireless connections. The exemplary techniques as discussed herein allow external imagers and sensors to be mounted in optimal positions on the outside of a vehicle while using wireless systems to enable data communications (e.g., dual-duplex communications) between an external mounted device and the electrical system of the vehicle, and to provide supply power from the inside of the vehicle to operate the external mounted device. The exemplary techniques as disclosed herein eliminate the need to utilize wired interconnects between the external mounted device and the vehicles electrical system, which would require formation of holes in the vehicle body, windshield, rear window, etc., to facilitate cabling. Instead, the exemplary techniques disclosed herein provide mounting configurations communications techniques to provide power from the inside of the vehicle to operate the external device as well as have dual-duplex communications between the internal and external components.

It is to be understood that the various layers, structures, and regions shown in the accompanying drawings are schematic illustrations that are not drawn to scale. Moreover, it is to be understood that same or similar reference numbers are used throughout the drawings to denote the same or similar features, elements, or structures, and thus, a detailed explanation of the same or similar features, elements, or structures will not be repeated for each of the drawings. The term “exemplary” as used herein means “serving as an example, instance, or illustration”. Any embodiment or design described herein as “exemplary” is not to be construed as preferred or advantageous over other embodiments or designs.

Further, it is to be understood that the phrase “configured to” as used in conjunction with a circuit, structure, element, component, or the like, performing one or more functions or otherwise providing some functionality, is intended to encompass embodiments wherein the circuit, structure, element, component, or the like, is implemented in hardware, software, and/or combinations thereof, and in implementations that comprise hardware, wherein the hardware may comprise discrete circuit elements (e.g., transistors, inverters, etc.), programmable elements (e.g., ASICs, FPGAs, etc.), processing devices (e.g., CPUs, GPUs, etc.), one or more integrated circuits, and/or combinations thereof. Thus, by way of example only, when a circuit, structure, element, component, etc., is defined to be configured to provide a specific functionality, it is intended to cover, but not be limited to, embodiments where the circuit, structure, element, component, etc., is comprised of elements, processing devices, and/or integrated circuits that enable it to perform the specific functionality when in an operational state (e.g., connected or otherwise deployed in a system, powered on, receiving an input, and/or producing an output), as well as cover embodiments when the circuit, structure, element, component, etc., is in a non-operational state (e.g., not connected nor otherwise deployed in a system, not powered on, not receiving an input, and/or not producing an output) or in a partial operational state.

It is to be further noted that the terms “imaging device” or “imager” or “imaging system” as interchangeably used herein denote systems and devices which collectively include optical devices, at least one photodetector array, and an associated readout integrated circuit (ROIC). The optical devices (e.g., mirrors, focusing lens, collimating lens, etc.) are configured to direct incident light to the photodetector array, wherein the photodetector array comprises a plurality of photodetectors (pixels) which are configured to convert the incident photonic energy to electrical signals (e.g., current or voltage). The ROIC is configured to accumulate the electric signals from each pixel and transfer the resultant signal (e.g., pixel data) to output taps for readout to a video processor. In some embodiments, the ROIC comprises a digital ROIC which generates and outputs digital pixel data to a video processor. The types of photodetectors or photosensors used will vary depending on whether the imager device is configured to detect, e.g., visible light, infrared (IR) (e.g., near, mid and/or far IR), or other wavelength of photonic energy within the electromagnetic spectrum. For example, in some embodiments, for visible light imagers, the photodetector array may comprise an RGB focal plane array (FPA) imager which comprises an array of red (R), green (G), and blue (B) pixels (e.g., Bayer Filter pixels), wherein a Bayer filter mosaic provides a color filter array for arranging RGB color filters on a photosensor array.

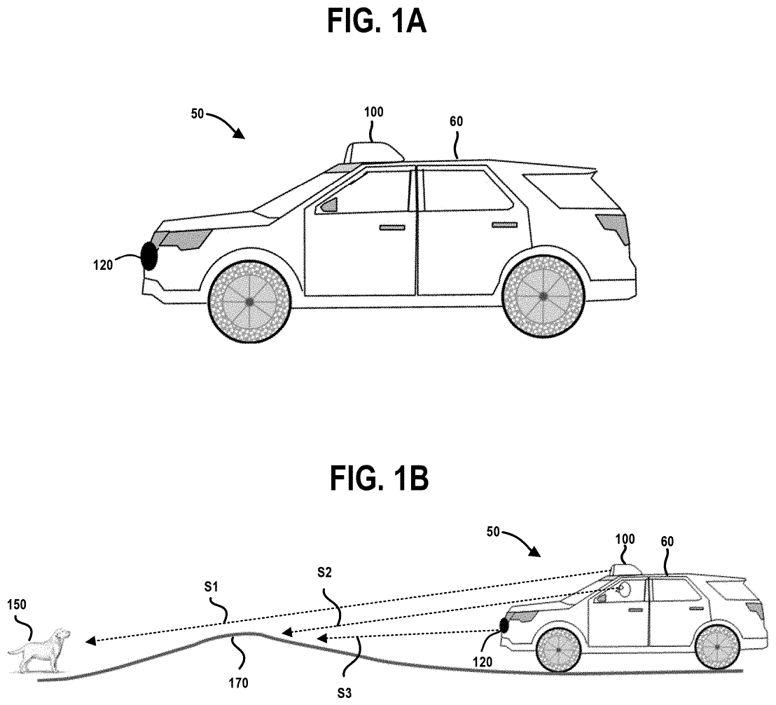

FIGS. 1A-B, 2A-B, 3, 4, 5, 6, and 7A-B illustrate exemplary embodiments for mounting imaging systems (e.g., cameras), sensors, or other types of data acquisition systems to an exterior of a vehicle in high positions on the exterior of the vehicle to achieve an enhanced field of view (FOV) for such imaging systems and sensors. For example, FIG. 1A schematically illustrates a configuration for externally mounting a forward-looking imaging device on a roof of a vehicle, according to an exemplary embodiment of the disclosure. In particular, FIG. 1A schematically illustrates a motor vehicle 50 having an external imaging device 100 mounted on a front region of the roof 60 of the vehicle 50 to implement, e.g., a forward-looking object detection system. In some embodiments, the external imaging device 100 comprises a visible light camera, a thermal IR camera, a multi-spectrum imaging system, or a combination thereof. FIG. 1A further illustrates an imaging device 120 mounted in a front grille of the vehicle 50.

The external roof-mounted imaging device 100 provides a greater FOV for forward-looking object detection, as compared to the grille-mounted imaging device 120. For example, FIG. 1B schematically illustrates the external roof-mounted imaging device 100 providing an optimal FOV for forward-looking object detection, according to an exemplary embodiment of the disclosure. In particular, FIG. 1B schematically illustrates the vehicle 50 approaching an object 150 (e.g., dog) which may be hidden from a driver's field of view when approaching (or on a rising side of) a hill 170. The external imaging device 100 mounted on the front-region of the vehicle roof provides a line-of-sight S1 that allows the external roof-mounted imaging device 100 to see the object 150, while the object 150 remains out of view of the driver and the grille-mounted imaging device 120 due to a limited line-of-sight S2 of the driver and a limited line-of-sight S3 of the grille-mounted imaging device 120. In this regard, the images captured using the external roof-mounted imaging device 100 facilitate the earliest possible forward-looking detection of objects from the perspective of the smart automated safety and control system of the vehicle. On the other hand, compared to the external roof-mounted imaging device 100, the cameras and sensors that are disposed on lower areas of the vehicle, such as in the grille, hood, external mirrors, or any position below the roof line, will have a more limited FOV of forward scenes and, thus, potential latency in object detection for, e.g., situations such as shown in FIG. 1B.

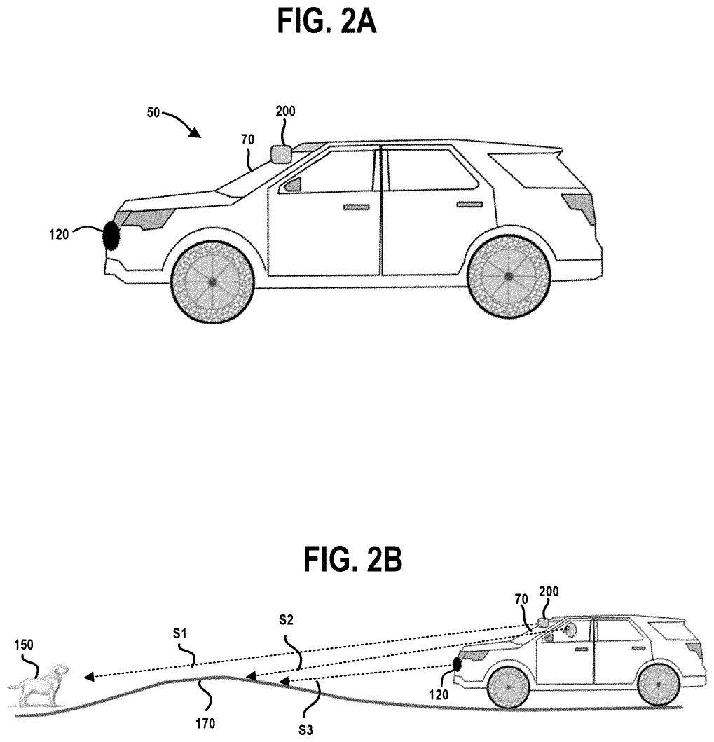

Next, FIG. 2A schematically illustrates a configuration for externally mounting a forward-looking imaging device on a windshield of a vehicle, according to an exemplary embodiment of the disclosure. In particular, FIG. 2A schematically illustrates an external imaging device 200 mounted on an upper region of a windshield 70 of the vehicle 50 to implement, e.g., a forward-looking object detection system. In some embodiments, the imaging device 200 comprises a visible light camera, a thermal IR camera, a multi-spectrum imaging system, or a combination thereof. The external windshield-mounted imaging device 200 provides a greater FOV for forward-looking object detection, as compared to the grille-mounted imaging device 120. For example, FIG. 2B schematically illustrates the external windshield-mounted imaging device 200 providing an optimal FOV for forward-looking object detection, according to an exemplary embodiment of the disclosure. In particular, FIG. 2B is similar to the exemplary embodiment of FIG. 1B, wherein it is shown that the external imaging device 200 mounted on the upper-region of the front windshield 70 provides a line-of-sight S1 that allows the external windshield-mounted imaging device 200 to see the object 150, while the object 150 remains out of view of the driver and the grille-mounted imaging device 120 due to a limited line-of-sight S2 of the driver and a limited line-of-sight S3 of the grille-mounted imaging device 120. In this regard, the images captured using the external windshield-mounted imaging device 200 on the upper portion of the front windshield 70 facilitate early forward-looking detection of objects from the perspective of the smart automated safety and control system of the vehicle, as compared to cameras and sensors that are disposed on lower areas of the vehicle, such as in the grille, hood, external mirrors, or any position below the roof line, which have a more limited FOV of forward scenes and, thus, potential latency in object detection for, e.g., situations such as shown in FIG. 2B.

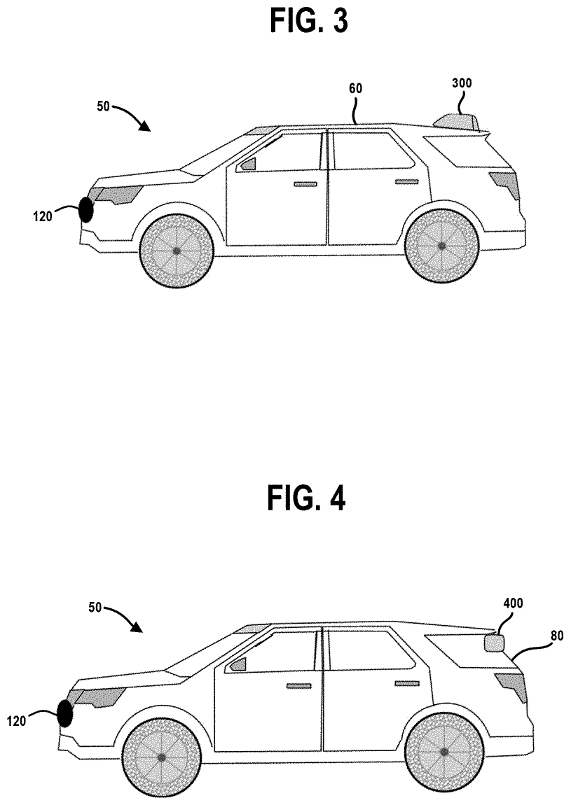

Next, FIG. 3 schematically illustrates a configuration for externally mounting a rearward-looking imaging device on a roof of a vehicle, according to an exemplary embodiment of the disclosure. In particular, FIG. 3 schematically illustrates the motor vehicle 50 having an external imaging device 300 mounted on a back region of the roof 60 of the vehicle 50 to implement, e.g., a rearward-looking object detection system. In some embodiments, the imaging device 300 comprises a visible light camera, a thermal IR camera, a multi-spectrum imaging system, or a combination thereof. The external roof-mounted imaging device 300 provides a greater FOV for rearward-looking object detection, as compared to imaging devices which are typically mounted in a back bumper of the vehicle.

Next, FIG. 4 schematically illustrates a configuration for externally mounting a rearward-looking imaging device on back window of a vehicle, according to an exemplary embodiment of the disclosure. In particular, FIG. 4 schematically illustrates an external imaging device 400 mounted on an upper region of a back window 8 of the vehicle 50 to implement, e.g., a rearward-looking object detection system. In some embodiments, the imaging device 400 comprises a visible light camera, a thermal IR camera, a multi-spectrum imaging system, or a combination thereof. The external window-mounted imaging device 400 provides a greater FOV for rearward-looking object detection, as compared to imaging devices which are typically mounted in a back bumper of the vehicle.

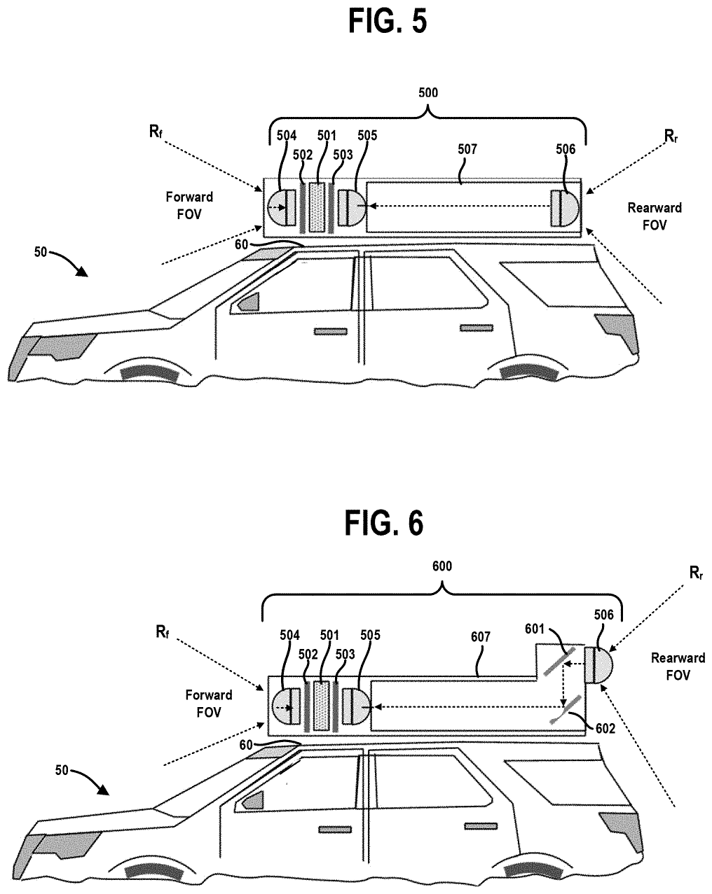

Next, FIG. 5 schematically illustrates a configuration for externally mounting a dual-direction imaging device on a roof of a vehicle, according to an exemplary embodiment of the disclosure. In particular, FIG. 5 schematically illustrates an exemplary embodiment of a dual-direction imaging device 500 which is mounted on the roof 60 of the vehicle 50 to provide both forward-looking and rearward looking object detection. The dual-direction imaging device 500 comprises a two-sided imager 501, a first shutter 502, a second shutter 503, an optical system comprising a first lens 504 (or first focusing lens), a second lens 505 (or second focusing lens), and a third lens 506 (or auxiliary lens), and an elongated light-directing tube 507. The dual-sided imager 501 comprises (i) a first side that is configured to receive incident photonic radiation (e.g., visible light, IR, etc.) from a forward incident scene, and (ii) a second side that is configured to receive incident photonic radiation from a rearward incident scene. This configuration allows the dual-direction imaging device 500 to capture images of forward and rearward views utilizing a single imager, i.e., the dual-sided imager 501.

More specifically, as shown in FIG. 5, incident radiation (R_{f}) from a forward-looking scene is focused by the first lens 504 and directed to the first side of the dual-side imager 501 when the first shutter 502 is open. Similarly, incident radiation (R_{f}) from a rearward looking scene is focused by the second lens 505 and directed to the second side of the dual-side imager 501 when the second shutter 503 is open. The third lens 506 (or auxiliary lens) is configured to capture the incident radiation (R_{f}) from a rearward looking scene and telescope the captured incident radiation from the back of the vehicle through the tube 507 to the focusing lens 505. With this configuration, only one side of the dual-sided imager 501 is exposed at a given time.

In particular, when capturing an image of the forward-looking scene, the first shutter 502 will be open and the second shutter 503 will be closed. In this instance, the dual-sided imager 501 will capture and detect the focused incident radiation (R_{f}) from the forward-looking scene (which is focused by the first focusing lens 504). On the other hand, when capturing an image of the rearward-looking scene, the second shutter 503 will be open and the first shutter 502 will be closed. In this instance, the dual-sided imager 501 will capture and detect the focused incident radiation (R_{f}) from the rearward-looking scene (which is focused by the second lens 505). In this regard, during operation of the dual-direction imaging device 500, one side of dual-imager device 501 will be isolated from exposure, while the other side is exposed, thereby allowing the single, dual-sided imager to capture images from the forward and rearward scenes in, e.g., an alternating manner. In some embodiments, the dual-direction imaging device 500 comprises a visible light camera, a thermal IR camera, a multi-spectrum imaging system, or a combination thereof.

Next, FIG. 6 schematically illustrates a configuration for externally mounting a dual-direction imaging device on a roof of a vehicle, according to another exemplary embodiment of the disclosure. In particular, FIG. 6 schematically illustrates an exemplary embodiment of a dual-direction imaging device 600 which is mounted on the roof 60 of the vehicle 50 to provide both forward-looking and rearward looking object detection. The dual-direction imaging device 600 is similar in structural configuration and operation as the dual-direction imaging device 500 of FIG. 5 with respect to the two-sided imager 501, the first and second shutters 502 and 503, the optical system comprising the first and second focusing lens 504 and 505, and the third lens 506 (or auxiliary lens).

However, the optical system of the dual-direction imaging device 600 of FIG. 6 comprises first and second reflecting mirrors 601 and 602, and an L-shaped light-directing tube 607 (e.g., periscope tube). The first and second reflecting mirrors 601 and 602 are disposed in parallel relation to each other, and set at a 45-degree angle with respect to the optical centerline of the focusing lens 505 and auxiliary lens 506. The periscope configuration enables the optical centerline of the auxiliary lens 506 to be disposed above the optical centerline of the focusing lens 505 (and thus the dual-sided imager 501) to provide an even greater FOV for rearward-looking object detection.

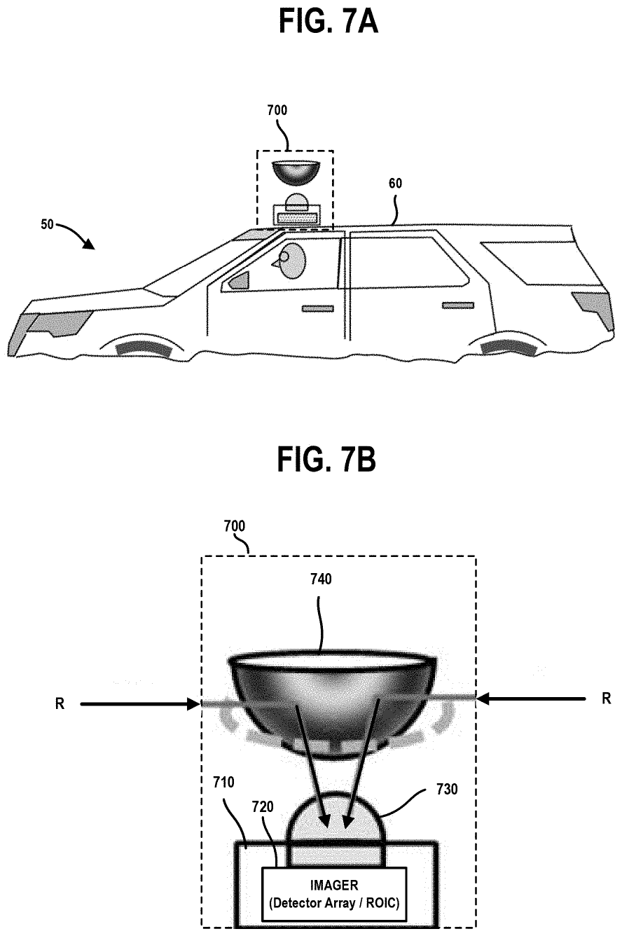

Next, FIGS. 7A and 7B schematically illustrate a configuration for externally mounting a 360-degree imaging system on a roof of a vehicle, according to an exemplary embodiment of the disclosure. More specially, FIG. 7A schematically illustrates an exemplary embodiment of a 360-degree imaging system 700 mounted on the roof 60 of the vehicle 50 to provide 360° viewing of incident scenes in forward-looking, rearward-looking, and sideward-looking directions around the vehicle 50. FIG. 7B schematically illustrates a configuration of the 360-degree imaging system 700, according to an exemplary embodiment of the disclosure. The 360-degree imaging system 700 comprises a protective housing 710 which contains an imager 720, a focusing lens 730, and a dome-shaped mirror 740.

In operation, the dome-shaped mirror 740 is configured to reflect incident radiation R, which is received in a 360-degree image view around the vehicle 50, to the focusing lens 730. The focusing lens 730 directs focused radiation to the imager 720 which captures image data of the 360-degree scene. As noted above, the imager 720 comprises a photodetector array (e.g., focal plane array) and an ROIC. In this configuration, the imager 720 essentially generates image data of a 360-degree scene based on the incident radiation corresponding to a circular horizontal view reflected from the dome-shaped mirror 740. While the spherical shape of the dome mirror 740 distorts the image data, software implemented in the computing system of the vehicle (and executed by processors) is configured to convert the image data with circular aberration to conventional images using geometric correction algorithms, as is known in the art.

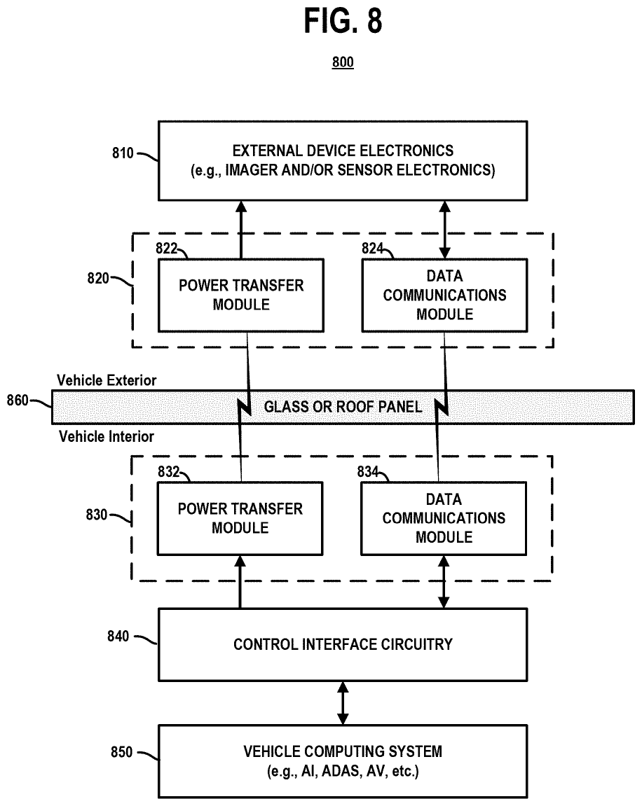

As noted above, exemplary embodiments of the disclosure provide for mounting external imaging devices and/or sensor devices outside a vehicle and connecting/coupling such external imaging devices and/or sensor devices to an electrical system of the vehicle using wireless connections to provide supply power to the external devices and allow bi-directional communication between the external devices and a computing system of the vehicle, without the need to form holes through the vehicle body, windshield, rear window, etc., for wired connections. For example, FIGS. 8, 9, 10, 11, and 12 schematically illustrate various systems to enable wireless coupling of power and data communication to external mounted imaging devices and/or sensor devices outside a vehicle, according to exemplary embodiments of the disclosure. In some embodiments, FIGS. 8, 9, 10, 11, and 12 schematically illustrate various systems to enable wireless coupling of power and data communication to the external mounted imaging devices and systems 100, 200, 300, 400, 500, 600, and 700 of FIGS. 1A-7, according to exemplary embodiments of the disclosure.

More specifically, FIG. 8 schematically illustrates a system 800 to enable wireless coupling of power and data communication to external imaging devices and/or sensor devices which are mounted outside of a vehicle, according to an exemplary embodiment of the disclosure. As shown in FIG. 8, the system 800 comprises external device electronics 810, a first coupler module 820 (alternatively, external coupler module 820), a second coupler module 830 (alternatively, internal coupler module 820), control interface circuitry 840, and a vehicle computing system 850. The external device electronics 810 comprise electronics associated with one or more imagers (e.g., visible light, IR, etc.) and/or one or more sensors (e.g., acoustic sensors, RADAR, etc.). In some embodiments, the external device electronics 810 comprise environmental sensors, such as temperature sensors, humidity sensors, and other sensors that can be utilized to detect environmental conditions within an external housing which contains the external device electronics 810 and the external coupler module 820.

The external coupler module 820 comprises a power transfer module 822 and a data communications module 824. Similarly, the internal coupler module 830 comprises a power transfer module 832 and a data communications module 824. The control interface circuitry 840 is configured to provide a control interface that enables the vehicle computing system 850 to communicate with the external device electronics 810 through wireless bi-directional data transfer enabled by the data communications modules 824 and 834. In some embodiments, the control interface circuitry 840 is configured to control operation of, e.g., the internal coupler module 830. The vehicle computing system 850 comprises a computer system having processors that execute programs to implement one or more artificial intelligence (AI) systems, ADAS, and/or autonomous vehicle control systems.

The external coupler module 820 and the internal coupler module 830 are configured to interface and cooperatively operate to enable wireless transfer of power and data through a physical medium 860 such as a glass window (e.g., windshield) or body panel (e.g., roof panel) of a vehicle. In particular, the power transfer modules 822 and 832 of the first and second coupler modules 820 and 830 are configured to cooperatively operate to transfer power from the electrical system of vehicle to the external device electronics 810, which is needed to operate the external device electronics 810 (e.g., imager, sensors, associated electronics, and other environmental reactive systems, etc.). Further, the data communications modules 824 and 834 of the first and second coupler modules 820 and 830 are configured to cooperatively operate to enable wireless bi-directional communication of data between the external device electronics 810 and the vehicle computing system 850.

The first and second coupler modules 820 and 830 can implement one of various types of systems/devices to enable wireless transfer of power and data through the physical medium 860 depending on, e.g., the material of the physical medium 860. For example, as noted above, the physical medium 860 can be a glass windshield or a back window of a vehicle. The physical medium can be a body panel (e.g., roof panel) of a vehicle, wherein the body panel may be formed of materials such as metallic materials, or composite materials such as fiberglass, carbon fiber, and various other types of plastics and polymers. The first and second coupler modules 820 and 830 are configured to enable wireless transfer of power and data through the physical medium 860, and eliminate the need to form via holes through the physical medium 860 to make electrical wire connections between the external and internal electronics (which can promote leaks).

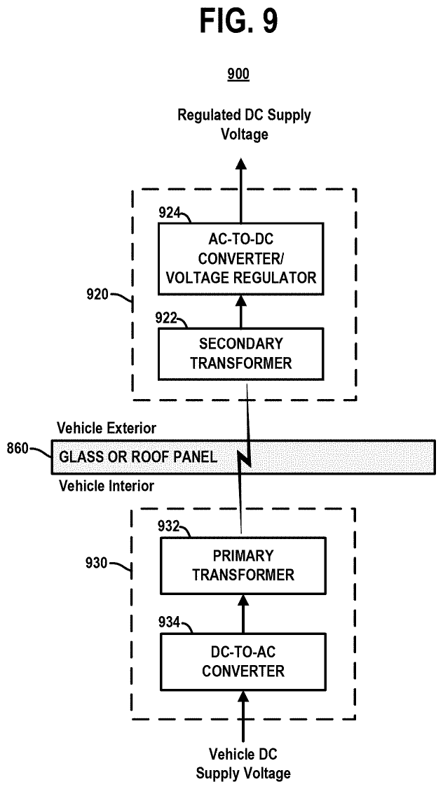

For example, in some embodiments, the power transfer modules 822 and 832 can implement power transfer modes based on, e.g., transformer coupling, optical coupling, etc., to transfer DC power from the vehicle internal electrical system to the external device electronics 810. Further, in some embodiments, the data communications modules 822 and 822 can implement data transfer modes based on, e.g., transformer coupling, optical coupling, acoustic coupling, wireless radio frequency (RF) communication, etc., to enable bi-directional data transfer and communication between the external device electronics 810 and the vehicle computing system 850. Exemplary power and data transfer modes will now be discussed in further detail in conjunction with, e.g., FIGS. 9, 10, 11, and 12.

For example, FIG. 9 schematically illustrates a power coupling system 900 which is configured to enable wireless transfer of power from an electrical system of a vehicle to external device electronics mounted on an outside of the vehicle, according to an exemplary embodiment of the disclosure. More specifically, FIG. 9 schematically illustrates an exemplary embodiment the power transfer modules 822 and 832 of the first and second coupler modules 820 and 830 (FIG. 8), according to an exemplary embodiment of the disclosure. The power coupling system 900 comprises a first power transfer module 920 (alternatively, external power transfer module 920) and a second power transfer module 930 (alternatively, internal power transfer module 930). The first and second power transfer modules 930 and 930 are configured to interface and cooperatively operate to provide transformer coupling of power through the physical medium 860 (e.g., windshield, rear window, roof panel, etc.).

In particular, the internal power transfer module 930 comprises DC-to-AC converter circuitry 934, and a primary transformer winding 932. The external power transfer module 920 comprises a secondary transformer winding 922, and AC-to-DC and voltage regulation circuitry 924. The primary and secondary transformer windings 932 and 922 are disposed in alignment on opposite sides of the physical medium 860 (e.g., mounted on the internal and external surfaces of the physical medium 860) in close proximity to enable sufficient electromagnetic coupling between the primary and secondary transformer windings 932 and 922. The DC-to-AC converter circuitry 934 is configured to convert DC power (e.g., DC voltage) of the internal electrical system of the vehicle to an AC voltage. The input AC voltage (which is generated by the DC-to-AC converter circuitry 934) is applied to the primary transformer winding 932 to thereby generate a magnetic flux that is coupled to the secondary transformer winding 922, and which causes the secondary transformer winding 922 to generate an output AC voltage via electromagnetic induction. The output AC voltage is applied to an input of the AC-to-DC converter and voltage regulator circuitry 924 to thereby generate a regulated DC supply voltage (and suitable current) to drive the external device electronics 810 and electronic components of the external data communications module 824 (FIG. 8). In some embodiments, the AC-to-DC converter and voltage regulator circuitry 924 is configured to generate two or more different DC supply voltages to provide different bias voltages, as needed, to operate the device electronics (e.g., imager(s)), sensors, environmental sensors, etc.

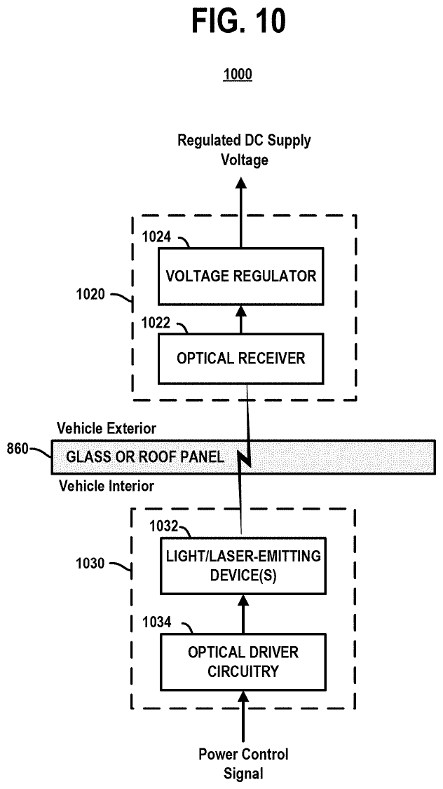

The exemplary power coupling system 900 (transformer coupling) can be implemented in instances where the physical medium 860 is formed of a glass material (e.g., windshield or rear window mounting), or formed of metallic, plastic material, polymer materials, or other materials typically used to form body panels of vehicles (e.g., roof panel mounting). In other embodiments, when the physical medium 860 comprises a glass material (e.g., windshield), a power coupling system can be implemented using optical coupling. For example, FIG. 10 schematically illustrates a power coupling system which is configured to enable wireless transfer of power, via optical coupling, from an electrical system of a vehicle to external device electronics mounted on an outside of the vehicle, according to another exemplary embodiment of the disclosure.

More specifically, FIG. 10 schematically illustrates a power coupling system 1000 which comprises a first power transfer module 1020 (alternatively, external power transfer module 1020) and a second power transfer module 1030 (alternatively, internal power transfer module 1030), which are configured to interface and cooperatively operate to couple power through the physical medium 860 (e.g., windshield, rear window) using an optical coupling system. In some embodiments, FIG. 10 schematically illustrates an exemplary embodiment the power transfer modules 822 and 832 of the first and second coupler modules 820 and 830 (FIG. 8). The internal power transfer module 1030 comprises optical driver circuitry 1034, and one or more light/laser-emitting devices 1032. The external power transfer module 1020 comprises an optical receiver 1022, and voltage regulator circuitry 1024. The light/laser-emitting devices 1032 and optical receiver 1022 are disposed in alignment on opposite sides of the physical medium 860 (e.g., mounted on the internal and external surfaces of a windshield or rear window) in close proximity to enable sufficient optical coupling.

In some embodiments, light/laser-emitting devices 1032 comprise photonic devices including, but not limited to, Light Emitting Diodes (LED) that produce light from the sides and tops thereof, or laser diodes such as Vertical-Cavity Surface-Emitting Laser (VCSEL) diodes (which emit light or optical beams vertically from top surfaces thereof), and Edge Emitting Laser (EEL) diodes (which emits light from the sides thereof), etc. The optical driver circuitry 1034 is configured to drive the light/laser-emitting devices 1032 and control modulation of the light/laser-emitting devices 1032, depending on the application. For example, for power coupling, the optical driver circuitry 1034 can be configured to continuously drive the light/laser-emitting devices 1032 to generate light as a continuous wave (CW) light to the optical receiver 1022. In other embodiments, the optical driver circuitry 1034 can be configured to modulate the light output of the light/laser-emitting devices 1032 (according to a given duty cycle) to generate a stream of light pulses that are applied to the optical receiver 1022. As noted below, optical modulation can be implemented to enable data transfer via optical coupling, wherein the optical driver circuitry 1034 is configured to drive the light/laser-emitting devices 1032 to modulate the emitted power of the light/laser-emitting devices 1032 to thereby generate and output pulsed optical laser signals, comprising a sequence of logic ones and zeros, corresponding to pulses of high or low power, respectively.

In some embodiments, the optical receiver 1022 comprises an array of photonic devices which are configured to convert the light, which is received from the light/laser-emitting devices 1032, into DC voltage. In some embodiments, the optical receiver 1022 comprises one or more pyroelectric sensor devices which are configured to generate DC electricity in response to incident laser pulses which heat pyroelectric crystal material, wherein temperature fluctuations of the pyroelectric crystal material of the pyroelectric sensor devices produce a change in the electrical charge on the surface of pyroelectric crystal material, which induces a corresponding voltage. Since it is the change in temperature that produces the current, pyroelectric detectors respond only to pulsed or modulated radiation.

In some embodiments, the optical receiver 1022 comprises a plurality of photodiodes that are configured to operate in a photovoltaic mode without an external bias. More specifically, in some embodiments, the optical receiver 1022 comprises a plurality of series and parallel-connected photodiodes, which are configured to generate a relatively large DC voltage. In silicon, a single photodiode operating in a photovoltaic mode can generate a voltage in a range of about 0.3V to about 0.4V. A plurality of serially-connected photodiodes can generate higher voltages at the output of the optical receiver 1002, while two or more parallel-connected strings of photodiodes can increase the magnitude of the current output of the optical receiver 1022.

The output of the optical receiver 1022 is connected to the voltage regulator circuitry 1024. The voltage regulator circuitry 1024 is configured to generate a regulated supply voltage from the electrical output of the optical receiver 1022 (e.g., generate and output a regulated DC voltage based on the AC voltage or current output from the optical receiver 1022), to thereby to drive the external device electronics 810 and electronic components of the external data communications module 824 (FIG. 8). In some embodiments, the voltage regulator circuitry 1024 is configured to generate two or more different DC supply voltages to provide different bias voltages, as needed, to operate the device electronics (e.g., imager(s)), sensors, environmental sensors, etc.). In some embodiments, the voltage regulator circuitry 1024 can be implemented using any voltage regulation framework comprising, e.g., a low-pass filter and analog regulator circuitry, which is suitable for the given application.

The optical coupling system of FIG. 10 is configured to utilize photonic energy at a wavelength which is sufficient to pass through the glass medium with minimal attenuation and not be subjected to destructive interference from external light. Further, in some embodiments, second power transfer module 1030 comprises an integrated lens system where each light/laser-emitting device 1032 comprises an integrated micro lens which is formed as part of the light/laser-emitting device 1032. The integrated micro lens is configured to collimate or otherwise focus the optical signals emitted from the light/laser-emitting device 1032 toward the optical receiver 1022.

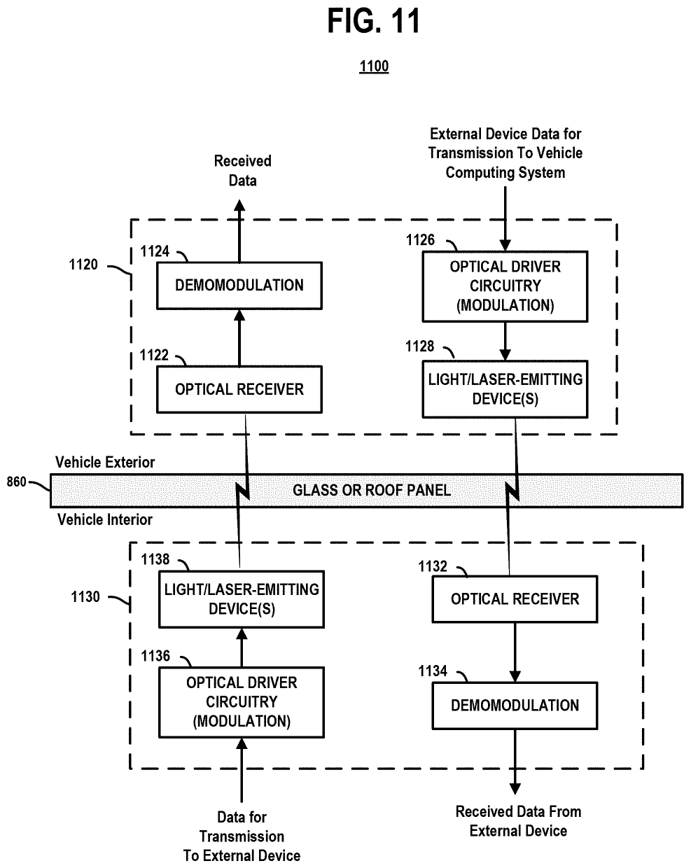

Next, FIG. 11 schematically illustrates a data transfer system which is configured to enable wireless bi-directional communication of data (via optical coupling) between a computer system of a vehicle, and external device electronics mounted on an outside of the vehicle, according to an exemplary embodiment of the disclosure. More specifically, FIG. 11 schematically illustrates a data transfer system 1100 which comprises a first data communications module 1120 (alternatively, external data communications module 1120) and a second data communications module 1130 (alternatively, internal data communications module 1130), which are configured to interface and cooperatively operate to enable wireless data transfer through the physical medium 860 (e.g., windshield, rear window) using an optical transmission system. In some embodiments, FIG. 11 schematically illustrates an exemplary embodiment the data communications modules 824 and 834 of the first and second coupler modules 820 and 830 (FIG. 8).

The external data communications module 1120 comprises an optical receiver 1122, a demodulation system 1124, optical driver circuitry 1126, and one or more light/laser emitting devices 1128. The internal data communications module 1130 comprises an optical receiver 1132, a demodulation system 1134, optical driver circuitry 1136, and one or more light/laser emitting devices 1138. The data transfer system 1100 provide full duplex communication between the vehicle computer system 850 and the external electronic devices 810. In particular, data from the vehicle computer system 850 is transmitted to the external electronic devices 810 over a data transmission path comprising the optical driver circuit 1136, the light-laser-emitting devices 1138, the optical receiver 1122, and the demodulation system 1124. Similarly, data from the external electronic devices 810 is transmitted to the vehicle computer system 850 over a data transmission path comprising the optical driver circuit 1126, the light/laser-emitting devices 1128, the optical receiver 1132, and the demodulation system 1134.

In some embodiments, the light/laser-emitting devices 1128 and 1138 of the first and second data communications modules 1120 and 1130 are the same or similar in configuration and operation as the light/laser-emitting devices 1032 (FIG. 10) discussed above. Further, in some embodiments, the optical receivers 1122 and 1132 of the first and second data communications modules 1120 and 1130 are the same or similar in configuration and operation as the optical receiver 1022 (FIG. 10) discussed above. Further, the optical driver circuitry 1126 and 1136 of the of the first and second data communications modules 1120 and 1130 are the same or similar in configuration and operation as the optical driver circuitry 1034 (FIG. 10) discussed above, except that the optical driver circuitry 1126 and 1136 implement a data modulation system which is configured to modulate the emitted light signals with data to be transmitted. The data modulation can be implemented using any suitable light modulation scheme to encode the data to be transmitted in the modulated light signals for wireless transmission through the glass medium 860. Further, the demodulation systems 1124 and 1134 of the first and second data communications modules 1120 and 1130 are configured to implement a corresponding demodulation scheme to extract the transmitted data from the modulated light signals, using techniques known to those of ordinary skill in the art.

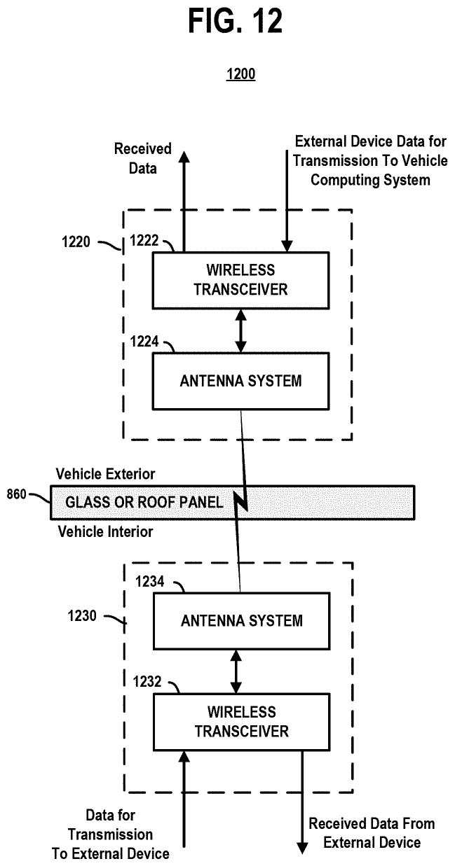

Next, FIG. 12 schematically illustrates a data transfer system which is configured to enable wireless bi-directional communication of data (via wireless RF transceivers) between a computer system of a vehicle, and external device electronics mounted on an outside of the vehicle, according to another exemplary embodiment of the disclosure. More specifically, FIG. 12 schematically illustrates a data transfer system 1200 which comprises a first data communications module 1220 (alternatively, external data communications module 1220) and a second data communications module 1230 (alternatively, internal data communications module 1230), which are configured to interface and cooperatively operate to enable wireless data transfer through the physical medium 860 (e.g., windshield, rear window) using radio frequency (RF) transceiver system. In some embodiments, FIG. 12 schematically illustrates an exemplary embodiment the data communications modules 824 and 834 of the first and second coupler modules 820 and 830 (FIG. 8).

The external data communications module 1220 comprises a wireless RF transceiver 1222, and antenna system 1224. Similarly, the internal data communications module 1130 comprises a wireless RF transceiver 1222, and antenna system 1224. In some embodiments, the RF transceivers 1222 and 1232 implement a standard wireless communications protocol such as near-field communication (NFC), Bluetooth®, Bluetooth Low Energy (BLE), or any suitable short-range RF communication protocol. In some embodiments, the antenna systems 1224 and 1234 comprise antenna radiators that are implemented using printed antenna technologies, and include components such as impedance matching networks, a duplexer, diplexer, transmission lines, filters, etc.

While FIGS. 11 and 12 illustrate exemplary data transfer modes using optical and RF systems, it is to be understood that the data communications modules 824 and 834 of the first and second coupler modules 820 and 830 (FIG. 8) can implement other wireless data communication schemes to enable wireless transfer of data through the physical medium 860 (e.g., windshield, read window, roof panel, etc.). For example, in some embodiments, the data communications modules 824 and 834 of the first and second coupler modules 820 and 830 can implement an acoustic system to enable wireless transfer of data through the physical medium 860. For example, an acoustic system would be similar to the optical system of FIG. 11 for full duplex communication, wherein the first and second coupler modules 820 and 830 would each comprise electromechanical transducers for transmitting and receiving modulated acoustic signals.

More specifically, to enable data transmission, the first and second coupler modules 820 and 830 would each comprise an associated electromechanical transducer (e.g., ultrasonic piezoelectric transducer) and associated transducer driver circuitry. For data transmission, the transducer driver circuitry would generate electrical signals to drive the electromechanical transducer (transmitted) to generate acoustic signals (by converting the electric signals into acoustic signals). For data transmission, the transducer driver circuitry would implement an acoustic modulation scheme configured to generate electrical signals that are modulated by the data to be transmitted through the physical medium 860, such that the modulated electrical signals result in the electromechanical transducer generating modulated acoustic signals (e.g., in effect, embed the data in the acoustic signals) to enable data transmission.

Further, to receive the acoustically transmitted data, the first and second coupler modules 820 and 830 would each comprise an associated electromechanical transducer receive (e.g., piezoelectric transducer) and associated demodulation system. To obtain the transmitted data, the electromechanical transducer (receiver) would receive and convert the modulated acoustic signals into electrical signals, and the demodulation system would extract the data from the electrical signals output from the electromechanical transducer (receiver) using any suitable technique known to those of ordinary skill in the art.

In other embodiments, the data communications modules 824 and 834 of the first and second coupler modules 820 and 830 (FIG. 8) can implement a transformer-coupled wireless data communication schemes to enable wireless transfer of data through the physical medium 860 (e.g., windshield, read window, roof panel, etc.). Such transformer-coupled embodiments for data transfer would be similar to the transformer-coupled power transfer system 900 of FIG. 9, but configured high-frequency data transfer. In such embodiments, the data communications modules 824 and 834 of the first and second coupler modules 820 and 830 would each comprise a data transmission system and primary transformer winding, with the data transmission system configured to generate a data modulated AC signal which is coupled to the primary transformer winding for transmission to a counterpart secondary transformer winding. To enable data receiving, the first and second coupler modules 820 and 830 would each comprise comprises a secondary transformer winding and data demodulation system, with data demodulation system configured receive a modulated AC signal output from the secondary transformer winding, and extract the data from the received modulated AC signal. In some embodiments, the modulation/demodulation can be implemented with a local oscillator (LO) frequency on the order of, e.g., 1 MHz, and using any suitable frequency modulation scheme.

The wireless data transfer techniques as discussed herein allow the external device electronics (e.g., imagers, sensors, etc.) to communicate with the vehicle computer system to send/receive commands to/from the vehicle computer system control, as well as send imager data, sensor data, and data regarding imager operating conditions and environmental conditions to the vehicle computer system for processing and monitoring. The captured images and imager operating conditions can be processed and monitored to control operation of the imagers. For example, the temperature within the housing, which contains the external electronic devices and imagers, mounted on the outside of the vehicle needs to be monitored and controlled by the vehicle processors. The imager devices will have an environmental response capability that needs to be monitored and controlled from both within the imager device housing and from the vehicle processors. These things will affect to output and performance of the imager device so they need to be monitored and controlled accordingly.

FIG. 13 schematically illustrates a configuration for externally mounting a forward-looking object detection system on a windshield of a vehicle, according to an exemplary embodiment of the disclosure. More specifically, FIG. 13 schematically illustrates an object detection system 1300 comprising an external housing unit 1310 and an internal housing unit 1320. In some embodiments, the external housing unit 1310 is mounted on an outer surface of the windshield 70 of the vehicle 50 in the upper-middle region of the windshield 70 behind a rear-view mirror 90. The internal housing unit 1320 is mounted on an inner surface of the windshield 70 in alignment with the external housing unit 1310. In this configuration, the external and internal housing units 1310 and 1320 are mounted behind the rear-view mirror 90, essentially out of the view of a person driving the vehicle 50. The external and internal housing units 1310 and 1320 can be mounted to the glass surfaces using suitable adhesive material such as epoxy material, etc.

In some embodiments, the external housing unit 1310 comprises, e.g., external device electronics 810 and the external coupler module 820 (FIG. 8). As noted above, the external device electronics comprise electronics and circuitry associated with one or more imaging systems (e.g., visible light imager, IR imager, etc.), and/or one or more sensors (e.g., acoustic sensors) for object detection. In addition, the external device electronics can include one or more environmental sensors (e.g., temperature sensor, humidity sensor) to monitor the environmental conditions of the electronics and the interior of the external housing unit 1310. In addition, the external housing unit 1310 may include one or more control systems to mechanically control components within the external housing unit 1310. For example, the external housing unit 1310 may include controllers to adjust the optics of the imagers to adjust the optical centerline of an imager and, thus, adjust the line-of-site S1 of an imager for a more optimized view. The external housing unit 1310 comprises a window 1312 to enable the passage of photonic energy for imaging. For IR imagers, the window 1312 comprises gemological material.

In some embodiments, the internal housing unit 1320 comprises the internal coupler module 820 and control interface circuitry 840 (FIG. 8). The internal housing unit 1320 wireless transfers power to the external housing unit 1310 using techniques as discussed herein, to provide DC supply power to the electronics and control systems within the external housing unit 1310. In addition, the components of the external and internal housing units 1310 and 1320 wirelessly communicate, bi-directionally, using techniques as discussed above. In some embodiments, the internal housing unit 1320 is electrically connected to the vehicle computing system using internal wiring.

The exemplary configuration shown in FIG. 13 eliminates the need to drill holes in the windshield 70 for wire/cable connections between components of the external and internal housing units 1310 and 1320. It is to be noted that automotive windshield and window materials are made of laminated layers of glass, polymers and adhesive. It is advantageous for the car manufacturers not to have to make holes in the glass material to facilitate implementation of the object detection and imaging systems disclosed herein. If a glass component had to be replaced, it would make the process difficult and more expensive. Moreover, vehicles that did not have external mounted object detection systems (e.g., cameras) would require a different glass component making double the necessary inventory to accommodate the two conditions.

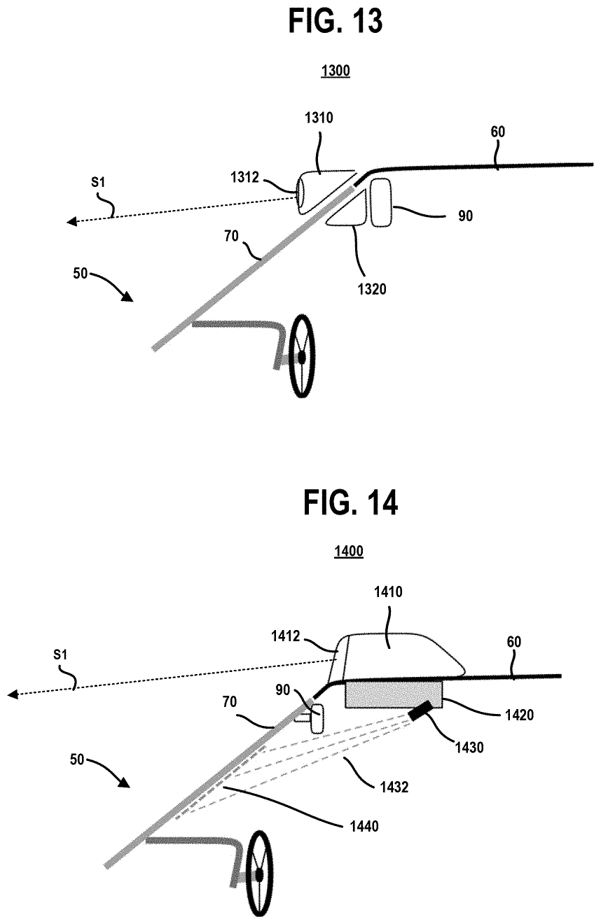

FIG. 14 schematically illustrates a configuration for externally mounting a forward-looking object detection system on a roof a vehicle, according to an exemplary embodiment of the disclosure. More specifically, FIG. 14 schematically illustrates an object detection system 1400 comprising an external housing unit 1410 and an internal housing unit 1420. In some embodiments, the external housing unit 1410 is mounted on the roof panel 60 in a front-middle region of the roof panel 60. The internal housing unit 1420 is mounted on an inner surface of the roof 60 in alignment with the external housing unit 1410.

In some embodiments, the external housing unit 1410 comprises, e.g., external device electronics 810 and the external coupler module 820 (FIG. 8). As noted above, the external device electronics comprise electronics and circuitry associated with one or more imaging systems (e.g., visible light imager, IR imager, etc.), and/or one or more sensors (e.g., acoustic sensors) for object detection. In addition, the external device electronics can include one or more environmental sensors (e.g., temperature sensor, humidity sensor) to monitor the environmental conditions of the electronics and the interior of the external housing unit 1410. In addition, the external housing unit 1410 may include one or more control systems to mechanically control components within the external housing unit 1410. For example, the external housing unit 1410 may include controllers to adjust the optics of the imagers to adjust the optical centerline of an imager and, thus, adjust the line-of-site S1 of an imager for a more optimized view. The external housing unit 1410 comprises a window 1412 to enable the passage of photonic energy for imaging. For IR imagers, the window 1412 comprises gemological material.

In some embodiments, the internal housing unit 1420 comprises the internal coupler module 820 and control interface circuitry 840 (FIG. 8). The internal housing unit 1420 wireless transfers power to the external housing unit 1410 using techniques as discussed herein, to provide DC supply power to the electronics and control systems within the external housing unit 1410. In addition, the components of the external and internal housing units 1410 and 1420 wirelessly communicate, bi-directionally, using techniques as discussed above. In some embodiments, the internal housing unit 1420 is electrically connected to the vehicle computing system using internal wiring.

As further shown in FIG. 14, in some embodiments, the internal housing unit 1420 comprises a laser or projector device 1430 which is configured to project 1432 a transparent display a light polarizing sheet 1140 on the inner surface of the windshield 70. This allows the glass surface of the windshield 70 to be turned into an interactive see-through display, which provides various types of relevant information to a driver including, e.g., notification and alerts regarding object detection, unsafe driving conditions, etc. Such alerts/notifications can be generated by the vehicle computer system analyzing image and sensor data acquired from, e.g., the roof-mounted object detection system 1400, and transmitted to projector electronics within the internal housing unit 1420.

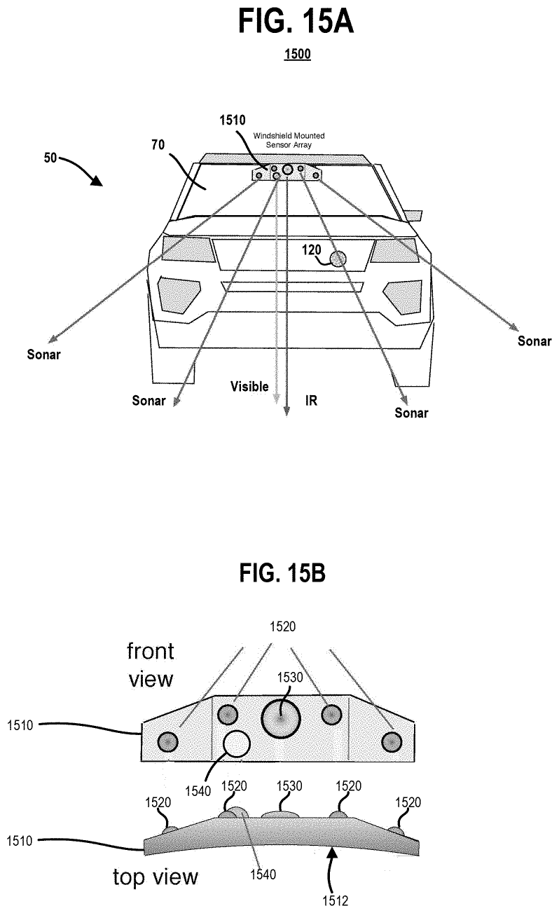

FIGS. 15A and 15B schematically illustrates a configuration for externally mounting a forward-looking object detection system on windshield of a vehicle, according to another exemplary embodiment of the disclosure. More specifically, FIG. 15A schematically illustrates an object detection system 1500 comprising an external housing unit 1510 mounted on an outer surface of the windshield 70 of the vehicle 50 in the upper-middle region of the windshield 70 behind a rear-view mirror. An internal housing unit (not specifically shown) is mounted on an inner surface of the windshield 70 in alignment with the external housing unit 1510.

FIG. 15B schematically illustrates details of the external housing unit 1510 comprising external device electronics and an external coupler module disposed within the eternal housing unit 1510. The external housing unit 1510 implements a multi-modal detection system including a plurality of acoustic sensors 1520, an IR imager 1520, and a visible light imager 1530. As shown in FIG. 15B, a front surface of the external housing unit 1510 comprises a plurality of angled surfaces on which acoustic sensors 1520 are disposed to enable a wide field of detection for the acoustic sensors 1520. In addition, a back surface 1512 of the external housing unit 1510 is curved to correspond to a curved profile of the outer surface of the windshield 70.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a first housing unit configured to mount to an external surface of a vehicle, wherein the first housing unit comprises a first coupler module, and electronic devices configured to enable object detection, wherein the electronic devices comprise an imaging system configured to generate image data of an incident scene in proximity to the vehicle; and
a second housing unit configured to mount to an inner surface of the vehicle, in alignment with the first housing unit, wherein the second housing unit comprises a second coupler module;
wherein the first coupler module and the second coupler module are configured to interface and cooperatively operate to enable (i) wireless transfer of power from an electrical system of the vehicle to the electronic devices in the first housing unit and (i) wireless bidirectional communication between the electronic devices within the first housing unit and a computer system of the vehicle.

2. The system of claim 1, wherein the external and inner surfaces of the vehicle comprise external and inner surfaces of a windshield of the vehicle.

3. The system of claim 1, wherein the external and inner surfaces of the vehicle comprise external and inner surfaces of a rear window of the vehicle.

4. The system of claim 1, wherein the external and inner surfaces of the vehicle comprise external and inner surfaces of a roof panel of the vehicle.

5. The system of claim 1, wherein the imaging system comprises an infrared imaging system.

6. The system of claim 1, wherein the imaging system comprises a visible light imaging system.

7. The system of claim 1, wherein the imaging system comprises a multi-spectrum imaging system.

8. The system of claim 1, wherein the second coupler module comprises a control interface configured to interface with the computer system of the vehicle.

9. The system of claim 1, wherein the computer system of the vehicle executes at least one of an automated driver-assistance systems (ADAS) and an autonomous vehicle control system.

10. The system of claim 1, wherein the electronic devices within the first housing unit comprise at least one acoustic sensor.

11. The system of claim 1, wherein the electronic devices within the first housing unit comprise at least one environmental sensor to detect an environmental condition within the first housing unit.

12. The system of claim 1, wherein the first and second coupler modules implement a transformer coupling system for the wireless transfer of power from the electrical system of the vehicle to the electronic devices in the first housing unit.

13. The system of claim 1, wherein the first and second coupler modules implement an optical coupling system for the wireless transfer of power from the electrical system of the vehicle to the electronic devices in the first housing unit.

14. The system of claim 1, wherein the first and second coupler modules implement an optical coupling system for the wireless bidirectional communication between the electronic devices within the first housing unit and the computer system of the vehicle.

15. The system of claim 1, wherein the first and second coupler modules implement an acoustic coupling system for the wireless bidirectional communication between the electronic devices within the first housing unit and the computer system of the vehicle.

16. The system of claim 1, wherein the first and second coupler modules implement a radio frequency communication system for the wireless bidirectional communication between the electronic devices within the first housing unit and the computer system of the vehicle.

17. A method, comprising:
mounting a first housing unit to an external surface of a vehicle, wherein the first housing unit comprises a first coupler module, and electronic devices configured to enable object detection, wherein the electronic devices comprise an imaging system configured to generate image data of an incident scene in proximity to the vehicle;
mounting a second housing unit to an inner surface of the vehicle, in alignment with the first housing unit, wherein the second housing unit comprises a second coupler module;
configuring the first coupler module and the second coupler module to cooperatively operate to enable (i) wireless transfer of power from an electrical system of the vehicle to the electronic devices in the first housing unit and (i) wireless bidirectional communication between the electronic devices within the first housing unit and a computer system of the vehicle.

18. The method of claim 17, wherein the external and inner surfaces of the vehicle comprise external and inner surfaces of a windshield of the vehicle.

19. The method of claim 17, wherein the external and inner surfaces of the vehicle comprise external and inner surfaces of a rear window of the vehicle.

20. The method of claim 17, wherein the external and inner surfaces of the vehicle comprise external and inner surfaces of a roof panel of the vehicle.
